(19) United States
(12) Patent Application Publication
(10) Pub. No.: US 2019/0359238 A1
(43) Pub. Date: Nov. 28, 2019

(54) RAILWAY YARD INTEGRATED CONTROL SYSTEM

(71) Applicants: Kun DING, Beijing (CN); Lei CUI, Beijing (CN); Xiuquan ZHAO, Beijing (CN)

(72) Inventors: Kun DING, Beijing (CN); Lei CUI, Beijing (CN); Xiuquan ZHAO, Beijing (CN)

(21) Appl. No.: 16/421,507

(22) Filed: May 24, 2019

(30) Foreign Application Priority Data
May 28, 2018 (CN) 201810521578.X

(51) Int. Cl. B61L 27/00; G06F 3/0486; G06F 3/0481; B61J 99/00

(52) U.S. Cl. CPC B61L 27/0022; G06F 3/0486; B61L 2201/00; B61J 99/00; G06F 3/0481

(57) ABSTRACT

A railway yard integrated control system includes a route controller, a dispatching terminal, a plan making module and a mobile terminal. A railway yard is substantively to transfer cars from one route to another, and to make plans, arrange routes and instruct running with regard to this repeatedly. The railway yard integrated control system of the present invention integrates functions of making shunting plans with computer assistance, automatic route selection and digital instruction together, to form automatic cascade. Moving cars on a human-machine interface by adopting the present invention will directly make the route convenient and inform the on-site transportation participants immediately. The solution of the present invention improves and optimizes the railway yard transportation procedure and brings benefits in aspects of downsizing staff, increasing efficiency, better security and profit.

### CROSS REFERENCE TO THE RELATED APPLICATIONS

This application is based upon and claims priority to Chinese Patent Application No. 201810521578.X, filed on May 28, 2018, the entire contents of which are incorporated herein by reference.

### TECHNICAL FIELD

The present invention belongs to the technical art of railway yard management technology and yard control, particularly relates to a railway yard integrated control system.

### BACKGROUND

A railway yard serves for freight, such as car storage, freight loading and unloading, car reorganization, car reversal, regional cargo transportation for car transfer, etc. The train running within one yard or among a plurality of yards generally adopts a shunting operation, usually as sudden forward and sudden backward reciprocating transportation. A power dedicated for shunting is called a shunting locomotive, the locomotive pulls or pushes the cars to move back and forth during reciprocating shunting.

Yards have commonly adopted information technology to manage present cars and shunting plans.

Present cars refer to a general term for the cars arranged in sequence existing in each line of a yard. Present cars comprise car attributes of each car within the yard: a car type, a self weight, a length, etc.; loading attributes: a departure station, an arrival station, a trade name, a load capacity, a consignor, etc.; distribution attributes: information such as a position and a sequence. Locomotives have never been incorporated into a unified management till now. Present cars are usually showed in tables on a human-machine interface, i.e., the car information is listed in order in a row or a column named by lines. Present cars have not been placed on a standard signal station monitoring topology yet to show in a car pictographic manner to replace the table manner.

A direction code of present cars an additional attribute of present cars, which is an important clue set for organizing shunting plans. A specific yard specifies a set of codes, and performs classification and assignment according to the destination direction/arrival station of the car transportation, the trade name, the car type or/and cargo line, the codes thereof are usually expressed in Chinese characters, characters or/and numbers.

A shunting plan is an abbreviation of a shunting list, it is an essential tool to conduct and coordinate the train running of all the shunting participants indoors/outdoors, and belongs to a standard formative table. There is a shunting cut in each line of the text of the shunting plan, each shunting cut comprises cells such as a cut sequence, a yard route name, a pick-up and drop orientation, numbers of cars and special requirements, etc.

One of the manners of manually managing shunting plans is spreadsheet editing technology, i.e., performing operation to each cell to achieve entry, modification and review of the plans. The relationship between the shunting plan in this manner and present cars is that present cars change with the saving of the shunting plan.

Present cars may be classified into planned present cars and actual present cars: planned present cars is a predicted result of present cars scene change when a shunting plan is saved but is not executed; actual present cars is a result of present cars scene change when a shunting plan is determined to be executed, actual present cars shall be synchronized with real car distribution on site.

The prior art has three tables on one interface: a table line present cars, a table of a shunting plan and a table of on-the-way present cars. A table of on-the-way present cars is a temporary table serving as a bridge. When a shunting cut plan is created, a car in the table of line present cars is dragged into the table of on-the-way present cars by a mouse, which is corresponding to coupling, and then a car in the table of on-the-way present cars is dragged into the table of line present cars, which is corresponding to uncoupling. The method requires operating buttons to adjust shunting directions before dragging a car, the horizontal position of the table of on-the-way present cars on the interface also changes. Since a locomotive does not belong to present cars, the method cannot be used for arranging plans for a light locomotive, a cut plan creation process is not directly related to the locomotive. The method does not integrate present cars/plan making with signal monitoring interface, which cannot directly reflect a causal relationship between plan making and route execution. In contrary with the former method, a shunting plan in this method is generated by changing the planned present cars.

A traditionally paper or screen-displayed shunting list is an output of a yard present cars/shunting plan information management system, which is used for conducting and coordinating all the shunting participants to operate routes, train running on site and binding operation. Using a shunting list as an input source of a shunting route to implement trial and practice of shunting automatic route has never stopped, however, it cannot completely replace manually operated route yet, and simple mistakes may even occur inevitably if it is not optimized. For example, it is not sure whether or not the car to be coupled exists on the line when processing a route for coupling certain line, it may require to wait for other plans to send the car to the position. For example, a reasonable space that shall be remained between a route end and a returning point is not known when processing a route returning from certain line to another line, if a farthest point is selected, it may not be used, then the route resource is wasted so as to affect the efficiency. The basic reason of these problems is that formative shunting plans lack necessary information. Thus, automatically controlling a route by merely a shunting list cannot avoid manually controlling the timing of route execution, however, if a default route is unsatisfactory before an instruction is manually triggered, other route solutions may be preferred among the alternatives manually, which is a semi-automatic route mode actually. Besides shunting plans, carrying on algorithm of present cars data which creates each shunting cut plan and current actual present cars data has never been envisaged for implementing shunting automatic route control.

A shunting operation is a process where a route is controlled indoors, a locomotive runs outdoors in route, both indoor and outdoor operations coordinate with each other. According to current regulations, after a route is prepared well indoors, a signal machine is turned on, on-site participants are informed by radio voice, then the car can be actuated, this is called shunting control. Some American yards are not equipped with ground signal machines, thus they have to totally depend on shunting control. So far, shunting control in yards completely depend on route operators to speak via talk back equipments during shunting procedure to conduct train running and operation.

As mentioned above, locomotives have never been incorporated into present cars management, thus, locomotives do not have formal shunting plans for individual shunting besides coordinating with shunting, for example, locomotives' entry into or departure from locomotive depots, light locomotive running merely depends on dictation/emotion, the shunting routes thereof can only be processed manually. On the other hand, routes of a yard are common resources, any manual route is interference for automatic routes, the interference being accidental, unexpected, irreconcilable and unable to be optimized, thus will seriously affect availability and effect of the entire automatic routes of a yard.

### SUMMARY

In order to solve the above problems, the present invention provides a rail yard integrated control system. In order to have a basic understanding on some aspects of the embodiments disclosed, the following provides a simple generalization. The generalization part is neither to make a general comment, nor to determine the key/important component elements or describe the protection extent of these embodiments. The unique purpose thereof is to present some concepts in a simple form as a prelude of the following detailed explanation.

The present invention adopts the following technical solution:

In some optional embodiments, a railway yard integrated control system is provided, it comprises: a route controller, a dispatching terminal, a plan making module, a plan execution module, a feedback execution module and a mobile terminal;

Present cars in a human-machine interface of the dispatching terminal are attached on a line of a signal monitoring station yard topology, present cars use modeling, color and characters of a locomotive/car to express sequence, type, bare weight, state, direction code, car number information, when the line space of the human-machine interface of the dispatching terminal cannot accommodate the present cars, the cars are overlapped until they are stacked, it switches to a present cars table temporarily when the resolution is not enough.

The human-machine interface of the dispatching terminal may drag the locomotive/car from one route to another by mouse to change the distribution of present cars, meanwhile, a shunting cut of a shunting plan is generated and displayed on the human-machine interface.

In some optional embodiments, the plan making module comprises: a shunting list generation unit and a planned present cars management unit;

The shunting list generation unit is configured to drag present cars to generate a shunting plan to simulate real shunting rules, the dragged locomotive/car is corresponding to a train running in shunting, the locomotive is a power, a mouse arc movement track indicates a shunting turnaround movement to determine the shunting leaving and arriving ends of the route, in order to pick up a car from a route, it shall comply with the stack rules, the on-the-way present cars of the dragged train must contain the whole from the end to the car to be dragged, the decrease of present cars in the line caused by the dragging result is corresponding to the coupling operation and the number of cars, the increase is corresponding to the decoupling operation and the number of cars.

The planned present cars management unit is configured to generate a unified management for the shunting list and provide the planned present cars scene information of each of the lines, the making of the plan is accomplished in iteration of interaction between the present cars and the shunting list, the present cars include cars and the locomotive.

In some optional embodiments, the plan making module further comprises: a shunting list/cut present cars reservation unit, every time present cars are dragged to generate a cut plan, the cut present cars information is recorded and stored in association with the shunting cut, for restoring the present cars before and after the change of the cut plan and the on-the-way present cars information of the train on a certain line, as important parameters of automatic route control of a plan execution link.

In some optional embodiments, the plan execution module comprises: a cut plan/cut present cars execution queuing unit, a route interference determination unit, a route selection: instruction/route generation unit, a timing selection: instruction/route automatic triggering unit, an actual present cars tracking unit and an instruction output unit;

The cut plan/cut present cars execution queuing unit is configured to determine the execution sequence of the cut plans, since the cut plans of different locomotives entering into execution phase are mixed and performed with a dynamic order management uniformly;

The route interference determination unit is configured to calculate parameters of a train length and weight according to the present cars information in the cut present cars for calculating the usage time of each route, so as to calculate and determine whether there exists interference among the routes to which the cut plans corresponding to different locomotives belong;

The route selection: instruction/route generation unit is configured to generate optimized instructions dynamically according to cut plans, each instruction is corresponding to a route, and comprises starting point and ending point information of the route, a cut plan corresponds to a plurality of instructions/routes, different route solutions may be found from a yard plane for selection, a dynamic optimization is performed when instructions/routes are generated;

The timing selection: instruction/route automatic triggering unit is configured to control a route processing timing by triggering instructions, the routes corresponding to the shunting plans shall select the timing in sequence to execute cut by cut;

The actual present cars tracking unit is configured to manage the actual present cars scene of each line uniformly, and update the distribution of the actual present cars on the human-machine interface lines, after the feedback module corresponds feedback information according to the router controller to the related state feedback of route instruction and state feedback of cut plans, cut present cars in the cut plan change to actual present cars when a cut is finished;

The instruction output unit is configured to convert the triggered instruction into a standard format that can be identified by the route controller to output to the route controller via data communication, when multiple route controllers administer different control regions, the instruction output unit distributes output instructions according to regions.

In some optional embodiments, the conditions for the route selection: instruction/route generation unit to perform a dynamic optimization are: a distance between a starting point of a turnaround route constituted by two routes and an ending point of a previous route shall be greater than a train length; a parallel route is preferred to avoid interference when interference is determined among routes of different cut plans, or a route with lower-level interference is preferred; a route with a shortest running distance is preferred when there is no interference; a straight route with the least ramps is preferred when there is no interference and the distances are the same; the route is changed so as to exclude the affected route out of the selection range when a route barrier is formed randomly by the route controller feedback or the human-machine interface operation.

In some optional embodiments, the conditions for the timing selection: instruction/route automatic triggering unit to perform an optimization are: the actual present cars and the planned present cars of the shunting cut are consistent with each other, to prevent an original intention of the shunting plan from being violated by a false trigger when present cars of different cut plans intersect; the one with priority is triggered first according to efficiency maximization calculation or user rules when interference is predicted among different routes: when it is too late to avoid the barrier or the barrier cannot be avoided, the trigger can be performed only when the barrier is excluded.

In some optional embodiments, the feedback execution module comprises: a feedback reception unit, an instruction/route execution state unit, a shunting cut plan execution state unit;

The feedback reception unit is configured to receive the real-time state information of switches, sections and signal machines collected on site during the route control process by the route controller, the real-time information includes: switch position/reverse position indication, section occupancy/clearance, section locking/unlocking, signal machine opening/closing information, the received feedback information is simultaneously used for updating the signal monitoring station yard topology of the human-machine interface of the dispatching terminal in real time;

The instruction/route execution state unit is configured to correspond to the execution state of the instruction/route through tracking algorithm in accordance with the site-collected fragmentation information received by the feedback reception unit, the execution state comprises successful route processing, route starting and route ending, the feedback of the execution state influences the timing selection and route selection calculation of the plan execution module, the timing of executing state feedback is simultaneously used for generating and outputting the corresponding text information to the mobile terminal for conducting a shunter/driver to implement the shunting control by voice.

The shunting cut plan execution state unit, the state feedback of the instruction influences the state change of the cut plan: a cut starting, a cut ending, then changes the actual present cars, the timing of a cut plan state feedback is simultaneously used for generating and outputting a shunting list to the mobile terminal to cause the mobile terminal display to update with the cut state change.

In some optional embodiments, mobile terminals corresponding to different locomotives receive, in a wireless communication manner, text and voice information that is transmitted by the plan execution module for conducting the on-site transportation participants, the human-machine interface of the mobile terminal displays the shunting list being executed by a corresponding locomotive, and scrolls dynamically since the plan is executed automatically cut by cut; in yards where route interference among different locomotives is likely to occur, timing selection is influenced by the binding operation ending information transmitted to the plan execution module via an operation of the mobile terminal.

In some optional embodiments, with the automatic route process, when a routing begins to select a route, the route processing is successful, a train arrives at a turnaround point, a train enters a line and begins a binding operation, a train waits to avoid because of route interference, a train waits for processing because of route default, the execution feedback module pushes voice reminding and notification information to the mobile terminal, the voice contents includes specific action requirements of each operation link, and provides essential line names, coupling/decoupling, number of cars, car code operation parameters.

The beneficial effects brought by the present invention: a shunting plan is made efficiently by adopting a dry running manner according to a transportation purpose, the dispatching is more intuitively, quickly and conveniently; a locomotive is incorporated into present cars elements when a plan is made, thus the dispatching process and the position information of the locomotive is checkable and traceably; automatic route completely replaces manually operated route, which improves labor productivity, eliminates security risks of manual errors, missing, and mistakes; digital conduction replaces manual deployment of shunting plans and manual shunting control during the shunting process, which is efficient and reduces labor intensity; the above automatic cascade generally improves and simplifies the operation procedure of yards, and brings benefits in aspects of downsizing staff, increasing efficiency, better security and profit.

For the above and related purpose, one or more embodiments include the features that will be explained in detail in the following and pointed out particularly in the claims. The following explanation and drawings of the specification illustrate in detail some exemplary aspects, and they indicate merely some of the manners that can be utilized by the principles of each of the embodiments. Other benefits and novelty features will be more obvious by combining with the following illustration and drawings of the specification, the disclosed embodiments include all the aspects and their equivalency.

### BRIEF DESCRIPTION OF THE DRAWINGS

FIG. 1 is a schematic diagram of a railway yard integrated control system of the present invention.

### DETAILED DESCRIPTION OF THE EMBODIMENTS

The following description and drawings sufficiently illustrate the detailed embodiments of the present invention so as to enable a person skilled in the art to practice them. Other embodiments may comprise changes on structure, logic, electrics, process and the like. Embodiments merely represent possible changes. Unless explicitly required, individual component and function is optional, and the operation sequence may be changed. Portions and features of some embodiments may be included in or replaced by portions and features of other embodiments. The scope of the embodiments of the present invention includes the whole scope of the Claims, and all the available equivalency of the Claims.

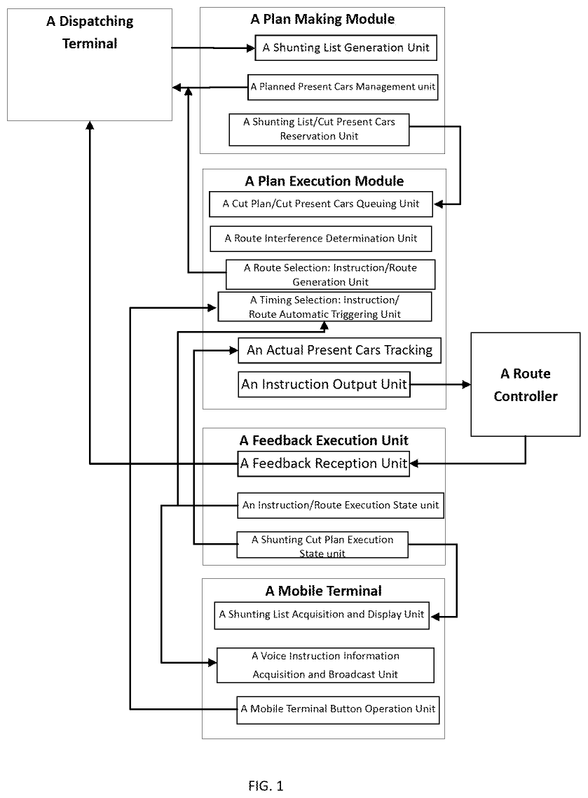

As shown in FIG. 1, in some explanatory embodiments, a railway yard integrated control system is provided, comprising: a route controller, a dispatching terminal, a plan making module, a plan execution module, a feedback execution module, a mobile terminal.

A human-machine interface of the dispatching terminal adopts a graphic work station or a normal computer configured with a display, a keyboard and a mouse to operate and customize the client software, and implement plan making and signal monitoring in a graphic manner. According to the scale of the railway, a single user or multiple users can be supported, and each dispatching terminal may be configured with a single screen or multiple screens.

A railway yard integrated control systems usually adopts IT technology, comprising database and application service. A railway yard integrated control system and a route controller adopt data communication interface technology, the railway yard integrated control system, as a upper layer, may perform a one-to-one match with the route controller in one room. However, a more powerful yard centralized control mode is that a railway yard integrated control system constitutes a one-to-multiple relationship with route controllers of different yards, the railway yard integrated control system and the human-machine interface of the dispatching terminal are established at the dispatch construction center, to achieve a unmanned remote control of the yard, and form a centralized control of regional or entire railway.

A route controller, which is used for performing a centralized control to switches and signal machines safely, receives and is controlled by instructions issued by the railway yard integrated control system, and provides route process feedback information to the railway yard integrated control system. A route controller is usually an existing railway signal technology, for example, a station computer interlocking system applied in railway yards in China or a plane yard special technology in America. These systems achieve a centralized control on the yard routes by collecting the trains' occupancy/clearance in the track sessions, controlling the point switch to shift and the shunting signal to turn on/off. The general usage method of these systems is an operator manually conducts on the interface to operate a route, the railway yard integrated control system turns the route controller into a unmanned lower-level execution unit that is completely driven by the shunting plan via a standard data interface.

A mobile terminal, which is used to acquiring the shunting plans issued by the railway yard integrated control system, conducts the yard transportation on-site participants digitally in text and voice information form. A mobile terminal may be one or more of a handheld radio, a mobile phone, a tablet computer.

Present cars on the human-machine interface of the dispatching terminal are attached on the lines of the signal monitoring station yard topology, that is, present cars and signal information are fused together in picture, which is more lifelike as the reality, and can sufficiently reflect a causal relationship between the shunting plan and the route. Present cars on the lines represent sequence, type, empty weight, state, direction code, and car code information by modeling, color and characters of the locomotive/car. If the lines of the human-machine interface cannot accommodate present cars, the cars may be placed overlapping. If too many cars are overlapped so that the effect is unclear, the cars may be placed in stack, only the car number information is displayed, when the shunting plan of this line is made, the interface may be switched into an interface of present cars table temporarily. The human-machine interface of the dispatching terminal may drag the cars and the locomotive from one line to another by a mouse to change the present cars distribution, meanwhile, a shunting cut of the shunting plan is generated, and displayed on the human-machine interface of the dispatching terminal.

A plan making module, which is specifically a dry running plan, comprises: a shunting list generation unit, a planned present cars management unit, a shunting list/cut present cars reservation unit.

The shunting list generation unit is configured to drag present cars to generating a shunting plan to imitate the real shunting rules, the dragged locomotive/car is corresponding to the running train in the shunting, the locomotive is a power, the mouse arc movement track indicates a shunting turnaround movement, to determine the shunting leaving and arriving ends of the route, taking a car out from a route shall comply with the stack rules, the on-the-way present cars of the dragged train must contain all the cars from the end to the car to be dragged. All the lines on the human-machine interface of the dispatching terminal are arranged horizontally, when both ends of the line may perform shunting, it is required to explicate the shunting is performed on the left side or the right side. A left arc or right arc mouse movement track is used for indicating a shunting direction when the car is dragged, and when the dragged locomotive/car approaches the target line, an indicator strip appears to assist to determine the entry line and direction of the shunting.

Stack rules refer to that, when a car is to be taken out from a line among a plurality of cars, the car cannot be directly dragged out, only when all the cars from one end of the line to the car to be dragged are taken out, can the car be coupled to another line, then the other cars are dragged back to the original line, or otherwise arranged. Such car-taking logic in stack manner derives from real shunting process.

The car removed from the stack result line determines the station tracks, coupling and number of cars of the cut plan; the car moved in the stack result line determines the station tracks, decoupling and number of cars of the cut plan.

The method forming a shunting cut plan according to the above rules is called a dry running method, the method is not a strategy optimization of making a plan, but is a convenient and quick means of generating a shunting plan with the assistance of a computer to directly imitate a shunting process according to the transportation destination of the shunting operation.

The planned present cars management unit is configured to generate a uniform management and to provide the scene information of the planned present cars of each of the lines for the shunting list, the making of the plan is accomplished in the iteration of interaction between the planned present cars and the shunting list.

The present cars of the present invention not only comprise cars, but also comprise a locomotive, which provides the dry running shunting with a power, and enables the light locomotive running to be included within the scope of the shunting cut plan and the automatic route uniformly. An additional advantage is that the position of a running locomotive can be directly observed from the human-machine interface of the dispatching terminal, rather than by memory, this function is very useful when there are many locomotives in the yard.

The shunting list/cut present cars reservation unit is configured to record and store the cut present cars information in association with the shunting cut once a cut plan is generated by each drag of present cars.

The shunting cut generated by each drag of present cars takes a planned cars scene formed by a previous cut drag as a precondition, an entire shunting plan is generated through such iteration cut by cut. The scene information of present cars of the line corresponding to each cut plan is abbreviated as cut present cars, which is saved with the cut plan, for restoring the information of present cars and on-the-way present cars of the train before and after being changed by the cut plan in the line to which the cut plan points, as important parameters of automatic route control of a plan execution link. After the route corresponding to each cut plan is used, cut present cars will convert to actual present cars.

The plan execution module comprises: a cut plan/cut present cars execution queuing unit, a route interference determination unit, a route selection: instruction/route generation unit, a timing selection: instruction/route automatic triggering unit, an actual present cars tracking unit and an instruction output unit.

An execution process of a shunting plan is to come out from a line of a previous cut and come into a present cut line, there may be only one route, or two routes constituting one turnaround, or N routes constituting N−1 turnarounds, wherein N>2. According to a plane of a specific railway yard, there are usually a plurality of route combinations for selection, preferring a proper route is referred to as route selection, optimizing and determining the execution timing of each route is referred to as time selection.

The cut plan/cut present cars execution queuing unit is configured to determine the execution sequence of the cut plans, since the cut plans of different locomotives entering into execution phase are mixed and performed with a dynamic order management uniformly, so that shunting plans of different locomotives can operate in parallel as long as the present cars do not have a conflict and the routes do not have interference. The timing selection process shall ensure that each plan is executed in series according to order cut by cut, so as to assure that the present cars run without error when different plans are executed, and the route with priority is selected when there is interference among routes, the optimized result is reflected in dynamically adjusting the sequence of the shunting plan/cut present cars queuing.

The route interference determination unit is used for judging the possibility of interference among routes in advance according to the on-the-way information of the train in the cut present cars. The on-the-way present cars of the train refers to a general term of the locomotive and the cars during a shunting operation process, which may be used to calculate a length of each cut of train and a total weight. The system stores map information of the yard, from which the length of each route can be acquired, then the train running distance equals to a sum of a route length and a train length. The weight of the train influences the starting up and brake acceleration of the train, the predicted running time of each route may be estimated by calculating the process of starting, coasting and slowing down, stopping of the train movement on the route. The system can acquire the actual train running time of each route according to the route state feedback record, and calibrate the calculation parameters of the route predicted running time based on the statistics. The necessary condition of interference among different cut routes of different plans is the calculated running time coincides. The necessary and sufficient condition of route interference determination is the time and space of different route overlaps simultaneously.

The route selection: instruction/route generation unit is configured to generate optimized instructions dynamically according to cut plans, each instruction corresponds to a route, and comprises starting point and ending point information of the route, a cut plan corresponds to a plurality of instructions/routes, different route solutions may be found from a yard plane for selection, to perform dynamic optimization when instructions/routes are generated. The condition to perform a dynamic optimization is a distance between a starting point of a turnaround route constituted by two routes and an ending point of a previous route shall be greater than a train length; a parallel route is preferred to avoid interference when interference is judged among routes of different cut plans, or a route with lower-level interference is preferred; a route with a shortest running distance is preferred when there is no interference; a straight route with the least ramps is preferred when there is no interference and the distances are the same; the route is changed to detour so as to exclude the affected route out of the selection range when a route barrier is formed randomly by the route controller feedback or the human-machine interface operation.

The timing selection: instruction/route automatic triggering unit is configured to control a route processing timing by triggering instructions, the routes corresponding to the shunting plans shall select timing in sequence to execute cut by cut. The optimization condition is the actual present cars shall be consistent with the planned present cars of the shunting plan, which is a necessary condition to make the execution result consistent with the plan intention of the transportation cars, so as to prevent an original intention of the shunting plan from being violated by a false trigger when present cars of different cut plans intersect, to make sure that no present cars error occurs in execution result when resent cars of different shunting plans intersect; the one with priority is triggered first according to efficiency maximization calculation or user rule order when interference is predicted among different routes, for example, train reception and departure is prior to shunting; sessions are made to automatically set up a barrier when a train goes through a defective shunting of track circuit, after clearance is checked out on site, the barrier is cleared, in addition, switches or signal machines may be set up with barriers manually due to the reasons like overhauling track side equipment or construction. In general, as long as there is a barrier on the route, it is too late to detour or the barrier cannot be avoided during route selection, instructions can be triggered only after the barrier is cleared manually.

The actual present cars tracking unit is configured to manage the actual present cars scene of each line uniformly, and update the distribution of the actual present cars on the human-machine interface lines, after the feedback module corresponds feedback information according to the router controller to the related state feedback of route instruction and state feedback of cut plans, along with the cut execution finishes, car position actually changes, and the cut present cars in the cut plan convert to actual present cars.

The instruction output unit is configured to convert the triggered instruction into a standard format that can be identified by the route controller to output to the route controller via data communication, to drive the route controller to begin processing the route. When multiple route controllers administer different control regions, the instruction output unit distributes output instructions according to regions.

The feedback execution module comprises: a feedback reception unit, an instruction/route execution state unit, a shunting cut plan execution state unit.

The feedback reception unit is configured to receive the real-time state information of switches, sections and signal machines collected on site during the route control process by the route controller, the real-time information includes: switch position/reverse position indication, section occupancy/clearance, section locking/unlocking, signal machine opening/closing information.

The received feedback information is simultaneously used for updating the signal monitoring station yard topology of the human-machine interface of the dispatching terminal in real time.

The instruction/route execution state unit is configured to correspond to the execution state of the instruction/route through tracking algorithm in accordance with the site-collected fragmentation information received by the feedback reception unit, the execution state comprises successful route processing, route starting and route ending, the feedback of the execution state influences the timing selection and route selection calculation of the plan execution module, the timing of executing state feedback is simultaneously used for generating and outputting the corresponding text information to the mobile terminal for conduct a shunter/driver to implement the shunting control by voice.

The instruction/route execution state unit is configured to, in accordance with the site-collected fragmentation information received by the feedback reception unit, correspond to the execution state of the instruction/route through tracking and calculation: route processing succeeds, route starts and route ends. The feedback of the execution state influences the timing selection and the route selection calculation of the plan execution module, the timing of executing state feedback is simultaneously used for generating and outputting the corresponding text information to the mobile terminal for conducting a shunter/driver to implement the shunting control by voice.

The shunting cut plan execution state unit, the route state corresponding to the cut plan is transferred to the shunting cut state, for example, the execution completion of all the routes corresponding to the cut plan indicates the shunting cut ends, e.g., the instruction feedback of the instruction influences the state change of the cut plan: a cut starting, a cut ending, then changes the actual present cars, the cut state thereof changes the timing due to the feedback and constitutes the timing of outputting to the terminal and updating the shunting list simultaneously, so that the display updates in real time with the change of the cut state.

The mobile terminal comprises: a shunting list acquisition and display unit, a voice instruction information acquisition and broadcast unit, a mobile terminal button operation unit. The present invention provides achieving fully automatic conduction based on fully automatic route, to replace manual deployment of a shunting plan and the function of manual shunting control during a route use process, mobile terminals corresponding to different locomotives receive text and voice information transmitted by the plan execution module for conducting the on-site transportation participants in a wireless communication manner.

The shunting list acquisition and display unit, when the shunting plan is used for execution, the shunting list is automatically pushed to screens of the mobile terminals of a driver of the corresponding locomotive and a shunter, and is dynamically updated and scrolled on the screen since the plan executes feedback cut by cut and the plan is modified.

The voice conduction information acquisition and broadcast unit is configured to push conduction text reminding and notification information to the mobile terminals of the driver of the locomotive corresponding to the route and the shunter when the following situations occur during execution. The specific situations include: the mobile terminal converts text into voice to broadcast via a microphone; a new plan is issued or the plan is changed; the route starts processing the shunting with a preparation notification; the route successfully processes the shunting with a starting notification; the train arrives at the turnaround point with a stopping notification; information reminding of a pick-up and drop orientation, number and key car code of entry into link combination is performed; other shunting routes executed with priority shall be avoided with a waiting notification; equipment on the route malfunctions with a notification of waiting for processing.

The mobile terminal button operation unit, in a yard where route interference among different locomotive is likely to occur, the on-site transportation participants may simply operate the feedback on the mobile terminal to the plan execution module when the in-line coupling operation ends, and trigger a subsequent route processing.

Preferably, if the mobile terminal is a car mobile terminal mounted on a locomotive, the screen of a tablet computer or a car display may simultaneously display a yard station representation topology the same with that on the indoor human-machine interface. The GPS location information of the tablet computer or a car computer may be utilized for calculating and dynamically displaying a distance between a train and a front signal machine, when the train approaches the blocking signal machine and the car speed exceeds a drop curve, the driver is prompted by voice broadcast to slow down or perform an emergency cut-off.

Some yards are connected with main tracks with requirements of freight train arrival-departure, thus, the plan making and automatic route method which is the same as that of shunting can be adopted: the locomotive/cars are dragged between the main tracks and lines within the yard to generate plans and instructions to drive receiving/delivering route control. The standard train prediction may be regarded as the on-the-way cars of train arrival-departure, the present cars within the yards update with departure and arrival of trains.

The railway yard integrated control system of the present invention integrates three functions of automatically generating plans by dragging a locomotive/car, automatic route and digital instruction together to form automatic iteration, which presents special effects and brand new yard operation mode, the feature of the mode is: it is only required to move the locomotive/car on the interface at will, the route will just follow, the operation can be performed upon instructions without waiting on site.

In order to exert the causal effect of dragging present cars and route, a shortcut operation may be used to drag only once to trigger the route, then the same shortcut operation is used to perform a subsequent cut, so as to achieve the purpose of planning while executing, thus the problem of frequent changing since the plans are made too long ago can be solved. Another usage of the shortcut manner operation is to perform “a subsequent cut” for plans of different locomotives in turn, which provides a method of making shunting plans and conducting in parallel. The integrated control improves and simplifies the operation procedure basically, the new procedure causes the task of controlling routes and conducting on-site operation to be replaced by computer completely, the productivity is improved, the security risk of manual misoperation of route can be eliminated.

The terms related in the above text are explained as follows:

A shunting plan: also referred to as a shunting list, it is a table available for conducting shunting operation, which is usually made by a shunter or duty staff of a yard according to transportation requirements, and is used by indoor and outdoor participants responsible for executing the plan. A shunting list consists of a header and main text, a line of the main text is also called a cut, each line is a cut plan, which is corresponding to a shunting route.

A shunting cut: the main text of a shunting plan table consists of shunting cuts (or referred to as cut plans), each cut consists of units of cut sequence, station tracks, pick-up and drop orientation, numbers of cars and notes, etc.

Cut present cars: plan present cars corresponding to each shunting cut. Since shunting only relates to one line, cut present cars merely comprise present cars of this line and the on-the-way present cars, combined with the cut plan, it can be seen that the changing situation of present cars distribution of the line corresponding to the cut plan.

On-the-way present cars: a locomotive and a car group of the train during running.

A train: a general term of the running locomotive and cars in train shunting of a yard, which is different from a train running on the main track.

A shunting locomotive: a locomotive dedicated for serving the shunting operation, the type is usually different from a leading locomotive.

A route: the road on ground for running preparation, the ground conditions of railway running are: correct switch opening, switch locking, no other trains occupying, no conflicting routes, exclusive resource, signal opening. Running is not allowed if no route on the ground. The routes are mainly classified into train routes of main track reception and departure and shunting routes within the yard, they differ in logic.

A route starting terminal: or referred to as a route starting point, according to a definition of a signal, the route starting terminal uses a signal machines as a certificate of entering into a route.

A route ending terminal: or referred to as a route ending point, according to a definition of a signal, the route starting terminal has a closed protective signal machine or an end line soil block as a terminating point of a route, which is forbidden to go through. If the line does not have a switch session, a differential back signal machine is used as an ending point of a route.

A shunting route: a route dedicated for shunting operation, a route use certificate thereof is a specific shunting signal machine. The shunting route supports an automatic unlocking function of switchback.

Switchback: stopping at a mid-position in a route, performing reverse running after processing switchback shunting route.

Route selection: a process of setting up a route, a portion from a switch to a forward route is first operated, then a session on route is locked to lock the switch, and then a protective signal machine on route is opened.

Route interference: switches, sessions or signal machine resources used by two different locomotives overlap, which constitutes a spatial interference. The running time is predicted to overlap, which constitutes a temporal interference. If spatial/temporal interference overlaps, then route interference occurs. Routes can only be used in series during interference, one route can be used after the other is finished.

A parallel route: although two routes of different locomotives have temporal overlap interference, routes that do not have interference in space with each other can be found through optimizing routes, which is called parallel routes.

A person skilled in the art shall also understand that, each explanatory logic frame, module, circuit and algorithm steps described in combination of the embodiments of the present text can be implemented into electronic hardware, computer software or their combination. In order to explicitly explain the exchangeability between the hardware and the software, the above discloses a general description on the function of each explanatory component, frame, module, circuit and algorithm steps. Whether to implement the function into hardware or software, it depends on specific applications and design constraint conditions applied on the entire system. A person skilled in the art may implement the function described in a flexible manner with respect to each specific application, however, this implementation strategy shall not be explained as protection scope deviating from the present disclosure.

What is claimed is:

1. A railway yard integrated control system, comprising: a route controller, a dispatching terminal, a plan making module, a plan execution module, a feedback execution module, and a mobile terminal;
wherein
present cars in a human-machine interface of the dispatching terminal are attached on a line of a signal monitoring station yard topology, the present cars use a modeling, a color and characters of a locomotive/car to express a sequence, a type, an empty weight, a state, a direction code, car number information, when a route space of the human-machine interface of the dispatching terminal is not sufficient for accommodating the present cars, the present cars are overlapped until stacked, the human-machine interface is switched to a present cars table temporarily when a resolution is not enough;
in the human-machine interface of the dispatching terminal, the locomotive/car is dragged from one route to another by a mouse to change a distribution of the present cars, meanwhile, a shunting cut of a shunting plan is generated and displayed on the human-machine interface.

2. The railway yard integrated control system according to claim 1, wherein the plan making module comprises: a shunting list generating unit and a planned present cars management unit:
the shunting list generation unit is configured to drag the present cars to generate the shunting plan to simulate real shunting rules, a dragged locomotive/car corresponds to a train running in shunting, the locomotive is a power, a mouse arc movement track indicates a shunting turnaround movement to determine a shunting leaving end and a shunting arriving end of a route, in order to pick up a car from the route, stack rules are required to be satisfied, on-the-way present cars of a dragged train contains the whole from an end to the dragged train, a decrease of present cars in the line caused by a dragging result corresponds to a coupling operation and a number of cars, an increase of present cars corresponds to a decoupling operation and the number of cars;
the planned present cars management unit is configured to generate a unified management for a shunting list and provide planned present cars scene information of each of the lines, a plan is made in an iteration of an interaction between the present cars and the shunting list, the present cars include cars and the locomotive.

3. The railway yard integrated control system according to claim 2, wherein the plan making module further comprises: a shunting list/cut present cars reservation unit, every time the present cars are dragged to generate a cut plan, cut present cars information is recorded and stored in association with the shunting cut, for restoring the present cars before and after a change of the cut plan and on-the-way present cars information of the train on a predetermined line, as important parameters of automatic route control of a plan execution link.

4. The railway yard integrated control system according to claim 1, wherein the plan execution module comprises: a cut plan/cut present cars execution queuing unit, a route interference determination unit, a route selection: instruction/route generation unit, a timing selection: instruction/route automatic triggering unit, an actual present cars tracking unit and an instruction output unit;
the cut plan/cut present cars execution queuing unit is configured to determine an execution sequence of cut plans, since the cut plans of different locomotives entering into an execution phase are mixed and performed with a dynamic order management uniformly;
the route interference determination unit is configured to calculate parameters of a length and a weight of the train according to the present cars information in the cut present cars, the parameters are configured for calculating a usage time of each route, so as to calculate and determine whether there exists interference among the routes to which the cut plans corresponding to the different locomotives belong;
the route selection: instruction/route generation unit is configured to generate optimized instructions dynamically according to the cut plans, each instruction of the optimized instructions corresponds to a route, and comprises a starting point information of the route and an ending point information of the route, each of the cut plans corresponds to a plurality of instructions/routes, different route solutions are found from a yard plane for selection, a dynamic optimization is performed when instructions/routes are generated;
the timing selection: instruction/route automatic triggering unit is configured to control a route processing timing by triggering the each instruction, the route corresponding to the shunting plan selects the timing in sequence to execute cut by cut;
the actual present cars tracking unit is configured to manage actual present cars scene of each line uniformly, and update a distribution of actual present cars on the lines of the human-machine interface, after the feedback execution module corresponds feedback information according to a router controller to a related state feedback of a route instruction and state feedbacks of cut plans, the cut present cars in the cut plan change to actual present cars when a cut is finished;
the instruction output unit is configured to convert a triggered instruction into a standard format that is identified by the route controller to output to the route controller via a data communication, when multiple route controllers administer different control regions, the instruction output unit distributes output instructions according to the different control regions.

5. The railway yard integrated control system according to claim 4, wherein conditions for the route selection: instruction/route generation unit to perform the dynamic optimization are: a distance between a starting point of a turnaround route constituted by two routes and an ending point of a previous route is greater than the length of the train; a parallel route to avoid an interference when the interference is determined among routes of different cut plans is used, or a route with a lower-level interference is used; a route with a shortest running distance is used when there is no interference; a straight route with least ramps is used when there is no interference and the distances are the same; the route is changed so as to exclude an affected route out of a selection range when a route barrier is formed randomly by a route controller feedback or an human-machine interface operation.

6. The railway yard integrated control system according to claim 4, wherein conditions for the timing selection: instruction/route automatic triggering unit to perform an optimization are: actual present cars and planned present cars of the shunting cut are consistent with each other, to prevent an original intention of the shunting plan from being violated by a false trigger when present cars of different cut plans intersect; the one with priority is triggered first according to an efficiency maximization calculation or user rules when the interference is predicted among different routes; when it is too late to avoid a barrier or the barrier cannot be avoided, a trigger is performed only when the barrier is excluded.

7. The railway yard integrated control system according to claim 4, wherein the feedback execution module comprises: a feedback reception unit, an instruction/route execution state unit, and a shunting cut plan execution state unit;
the feedback reception unit is configured to receive real-time state information of switches, sections and signal machines collected on site during a route control process by the route controller, the real-time state information includes: switch position/reverse position indication, section occupancy/clearance, section locking/unlocking, signal machine opening/closing information, received feedback information is simultaneously used for updating the signal monitoring station yard topology of the human-machine interface of the dispatching terminal in real time;
the instruction/route execution state unit is configured to correspond to an execution state of the instruction/route execution state unit through a tracking algorithm in accordance with site-collected fragmentation information received by the feedback reception unit, the execution state comprises successful route processing, route starting and route ending, a feedback of the execution state influences the timing selection and route selection calculation of the plan execution module, the timing of executing state feedback is simultaneously used for generating and outputting corresponding text information to the mobile terminal for conducting a shunter/driver to implement a shunting control by voice;
the shunting cut plan execution state unit, the state feedback of the instruction influences the state change of the cut plan: a cut starting, a cut ending, then changes the actual present cars, the timing of a cut plan state feedback is simultaneously used for generating and outputting a shunting list to the mobile terminal to cause a mobile terminal display to update with a cut state change.

8. The railway yard integrated control system according to claim 1, wherein mobile terminals correspond to different locomotives receive, in a wireless communication manner, text and voice information that is transmitted by the plan execution module for conducting on-site transportation participants, the human-machine interface of the mobile terminal displays the shunting list being executed by a corresponding locomotive, and scrolls dynamically since the plan is executed automatically cut by cut; in yards where route interference among different locomotives is likely to occur, the timing selection is influenced by binding operation ending information transmitted to the plan execution module via an operation of the mobile terminal.

9. The railway yard integrated control system according to claim 8, wherein with an automatic route process, when a routing begins to select a route, a route processing is successful, a train arrives at a turnaround point, the train enters a line and begins a binding operation, the train waits to avoid because of route interference, the train waits for processing because of route default, the execution feedback module pushes a voice reminding and notification information to the mobile terminal, voice contents includes specific action requirements of each operation link, and provides essential line names, coupling/decoupling, number of cars, car code operation parameters.

10. The railway yard integrated control system according to claim 5, wherein conditions for the timing selection: instruction/route automatic triggering unit to perform an optimization are: actual present cars and planned present cars of the shunting cut are consistent with each other, to prevent an original intention of the shunting plan from being violated by a false trigger when present cars of different cut plans intersect; the one with priority is triggered first according to an efficiency maximization calculation or user rules when the interference is predicted among different routes; when it is too late to avoid a barrier or the barrier cannot be avoided, a trigger is performed only when the barrier is excluded.

11. The railway yard integrated control system according to claim 4, wherein mobile terminals correspond to different locomotives receive, in a wireless communication manner, text and voice information that is transmitted by the plan execution module for conducting on-site transportation participants, the human-machine interface of the mobile terminal displays the shunting list being executed by a corresponding locomotive, and scrolls dynamically since the plan is executed automatically cut by cut; in yards where route interference among different locomotives is likely to occur, the timing selection is influenced by binding operation ending information transmitted to the plan execution module via an operation of the mobile terminal.

12. The railway yard integrated control system according to claim 11, wherein with an automatic route process, when a routing begins to select a route, a route processing is successful, a train arrives at a turnaround point, the train enters a line and begins a binding operation, the train waits to avoid because of route interference, the train waits for processing because of route default, the execution feedback module pushes a voice reminding and notification information to the mobile terminal, voice contents includes specific action requirements of each operation link, and provides essential line names, coupling/decoupling, number of cars, car code operation parameters.
